(19) United States
(12) Patent Application Publication
(10) Pub. No.: US 2011/0193887 A1
(43) Pub. Date: Aug. 11, 2011

(54) TRANSFORMER, CIRCUIT BOARD HAVING THE TRANSFORMER, AND DISPLAY DEVICE HAVING THE CIRCUIT BOARD

(75) Inventors: Dae-Sik LEE, Asan-si (KR); Chung-Won CHOI, Asan-si (KR); Gye-Won YOON, Masan-si (KR); Ki-Bok JANG, Masan-si (KR); Sung-Kyu PARK, Masan-si (KR); Yeong-Chil HEO, Masan-si (KR)

(73) Assignee: Samsung Electronics Co., Ltd., Suwon-si (KR)

(21) Appl. No.: 12/939,430

(22) Filed: Nov. 4, 2010

(30) Foreign Application Priority Data
Feb. 11, 2010 (KR) 10-2010-0012647

(51) Int. Cl. G09G 5/10; H01F 17/04; H01F 27/29; H01F 27/06; G09G 3/36

(52) U.S. Cl. 345/690; 336/221; 336/192; 336/65; 345/102

(57) ABSTRACT

A transformer including; a bobbin, a coil wound to the bobbin, a core inserted within the bobbin and a soldering pin disposed connected to the bobbin, wherein the soldering pin has at least one first hole.

This application claims priority to Korean Patent Application No. 10-2010-0012647, filed on Feb. 11, 2010, and all the benefits accruing therefrom under 35 U.S.C. §119, the content of which in its entirety is herein incorporated by reference.

### BACKGROUND OF THE INVENTION

(a) Field of the Invention

The present invention relates to a transformer, a circuit board, and a display device including the circuit board. More particularly, the invention relates to a solder pin shape and a connection line pin shape of the transformer, thereby ensuring stability when mounting the transformer to the circuit board, and as a result, the solder pin shape and connection line pin shape are capable of ensuring the reliability of the circuit board and the display device mounted with the transformer.

(b) Description of the Related Art

A transformer used as a circuit element has a comparatively large volume when compared with other surface mounted elements on a circuit board, and a voltage may be generated according to a turn ratio within the transformer such that the reliability thereof is important when it is mounted on the circuit board.

The transformer is generally mounted to the circuit board to be used for transformation of voltages and currents, and for example, is used as a constituent element of an inverter to drive a cold cathode fluorescent lamp (“CCFL”).

In a case wherein the transformer is used with a liquid crystal display (“LCD”), a liquid crystal panel is not a self-emissive device such that a backlight is used as a light source, and the transformer may be used as a part of an inverter circuit to drive the backlight unit in the LCD.

In this case, if the mounting state of the circuit board including the transformer is deteriorated, the circuit board may be defective for use in the display device, or may sometimes generate an arc event, thereby possibly causing unwanted consequences such as fumes and/or ignition.

Also, when the transformer has a larger volume and/or a thicker thickness than other elements mounted on the circuit board, the total thickness of the mounted circuit board is increased, and resultantly the whole thickness of the display device is increased.

Recently, as products for use in displays or other consumer electronics have trended to be manufactured to be small and thin, a mounting technique wherein the transformer may be thin and reliably mounted have been important issues.

### BRIEF SUMMARY OF THE INVENTION

The present invention provides exemplary embodiments of a circuit board and exemplary embodiments of a display device capable of ensuring stability of the mounting of a transformer on the circuit board and reducing the thickness thereof.

In one exemplary embodiment, when mounting the transformer to the circuit board, a hole is formed in a surface of a soldering pin soldered along with the circuit board, and a connection line of the transformer is disposed on a central part of the soldering pin.

In such an exemplary embodiment, an empty space passing through the substrate, e.g., defined by the substrate, is formed on the circuit board mounted with the transformer, and the transformer is disposed in the empty space such that the entire thickness of the circuit board combined with the transformer may be reduced. In one exemplary embodiment, the soldering pin has a curved portion to increase adhesion intensity, an additional groove is formed in the circuit board as well as a portion where the transformer and the circuit board are soldered to each other, and the shape of the transformer is formed to correspond to the groove, thereby increasing the adhesion intensity thereof.

When mounting the transformer to the circuit board, the hole is formed to the pin of the transformer that is soldered to the circuit board, and the connection line pin of the transformer is disposed on the central part of the pin for surface mounting such that defects such as pad breakaway may be minimized, and the adhesion intensity and the stability of the connection line pin, and thereby the overall reliability of the product, may be increased.

Also, in one exemplary embodiment the shape of the soldering pin has a curved line, an additional groove is formed in the circuit board as well as the portion where the transformer and the circuit board are soldered to each other, and the shape of the transformer is formed to correspond to the groove, thereby increasing the adhesion intensity.

In such an exemplary embodiment, the hole is formed in the circuit board mounted with the transformer, the transformer is placed in the hole such that the entire thickness of the circuit board including the transformer is reduced, and resultantly the thickness of the display device including the transformer may be reduced.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1A is a top plan view showing a shape of an exemplary embodiment of a transformer according to the present invention;

FIG. 1B is an enlarged view of the region “B” of FIG. 1A;

FIG. 2A is a top plan view showing a shape of another exemplary embodiment of a transformer according to the present invention;

FIG. 2B is an enlarged view of the region “B” of FIG. 2A;

FIG. 3A is a front perspective view of another exemplary embodiment of a transformer and a circuit board according to the present invention;

FIG. 3B is a cross-sectional view taken along line B-B′ in FIG. 3A;

FIG. 4A is a front perspective view of another exemplary embodiment of a transformer according to the present invention;

FIG. 4B is a cross-sectional view taken along line B-B′ in FIG. 4A;

FIG. 5 is a cross-sectional view of the exemplary embodiment of a transformer according to FIG. 4A in a configuration where the transformer is mounted to a circuit board;

FIG. 6 is a rear perspective view of another exemplary embodiment of a transformer according to the present invention;

FIG. 7A is a rear perspective view of the exemplary embodiment of a transformer according to FIG. 6 in a configuration where the transformer is mounted to a circuit board;

FIG. 7B is an enlarged view of the region “B” of FIG. 7A;

FIG. 8A is a front perspective view of another exemplary embodiment of a transformer according to the present invention in a configuration wherein the transformer is mounted to a circuit board;

FIG. 8B is a cross-sectional view taken along line B-B′ of FIG. 8A; and

FIG. 9 is a schematic view of an exemplary embodiment of a display device according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, an exemplary embodiment of the present invention will be described with reference to the drawings.

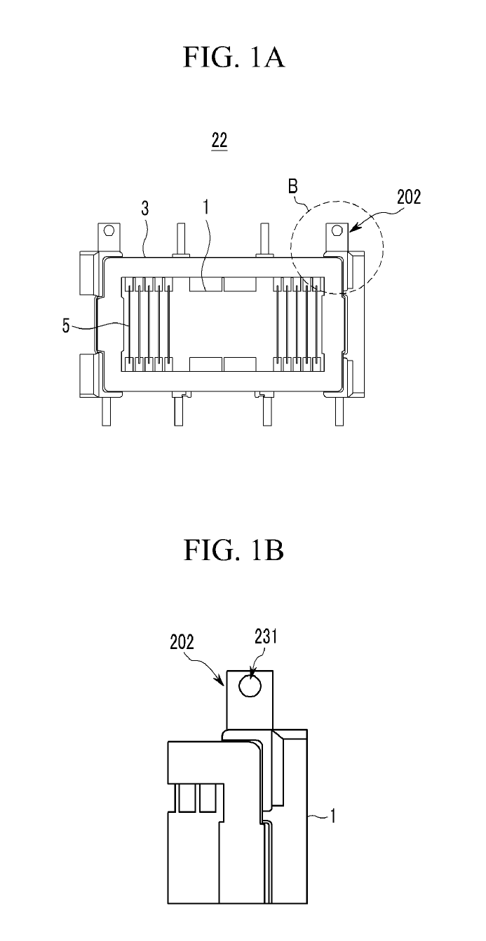

FIGS. 1A and 1B are top plan views showing a shape and a partial enlarged region of an exemplary embodiment of a transformer according to the present invention, respectively.

Referring to FIG. 1, an exemplary embodiment of a transformer 22 according to the present invention includes a bobbin 1 made of an insulating material, exemplary embodiments of which include plastic and other materials with similar characteristics and including a plurality of partitions, a coil 5 wound to the bobbin 1, a core 3 generally made of a ferrite material and inserted in the central part of the bobbin 1, and having an edge enclosing an edge of the bobbin 1 wound with the coil 5, a connection line pin (not shown in FIGS. 1A and 1B) connected to the coil 5, and a soldering pin 202 inserted in, and supported by, the bobbin 1 for mounting to a circuit board (not shown in FIGS. 1A and 1B) and connecting with other parts.

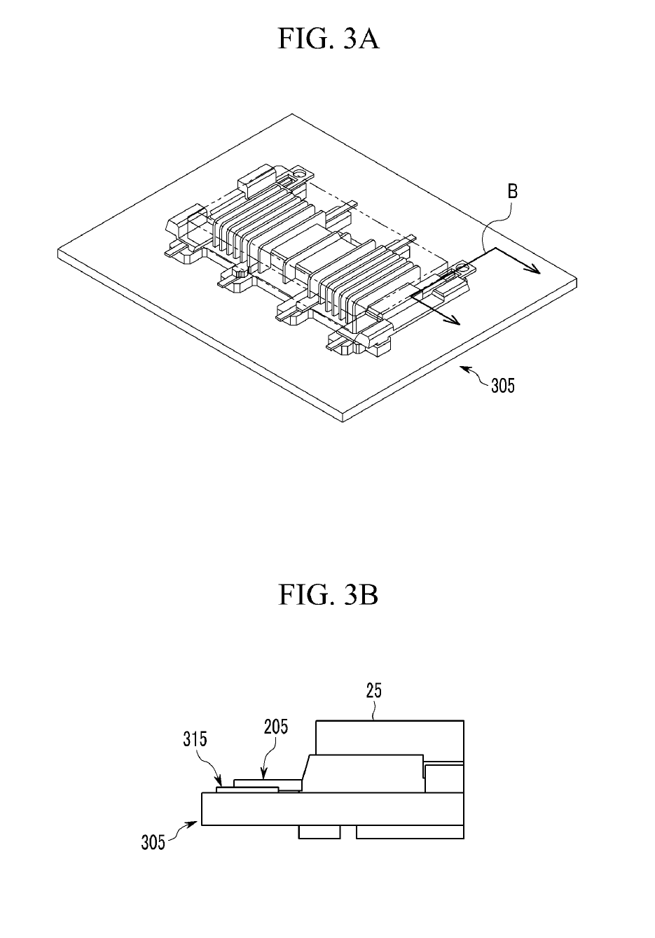

The soldering pin 202 is contacted with the surface of a solder surface (315 in FIG. 3) and is soldered when mounting the transformer 22 to the circuit board (305 in FIG. 3).

Here, as a surface where the soldering pin 202 and the solder surface 315 contact with each other is increased, the adhesion reliability is also increased such that the possibility of a cold solder connection being formed is also increased.

In the event that the cold solder connection is formed, the circuit part including the transformer including the same may not be normally operated, e.g., the circuit part may be defective, and an arc may generated according, thereby undesirably generating fumes and ignition.

Accordingly, in an exemplary embodiment of the present invention, at least one first hole 231 is formed in the soldering pin 202 of the transformer 22 in order to reduce a contact area thereof with the solder surface 315, and thereby also decrease a probability of an undesirable cold soldering configuration.

In the exemplary embodiment of FIG. 1, one first hole 231 is formed for one soldering pin 202 in a one-to-one ratio, however alternative exemplary embodiments include configurations wherein two or more first holes may be formed in the region of the soldering pin 202 which contacts the solder surface 315.

In the exemplary embodiment of FIG. 1, the soldering pin 202 has a circle or ellipse shape, however the shape and the type thereof are not limited thereto.

As described above, the first hole 231 is formed in the soldering pin 202 such that the solder fills in the region where the first hole 231 is formed in the soldering pin 202, thereby forming a closed path when soldering the circuit board, and the solder may have a column shape within the region of the first hole 231 between the upper portion of the soldering pin 202 and the solder surface 315.

Through this method, the solder passing through the soldering pin 202 inside the region of the soldering pin 202 increases the adhesion intensity after the soldering is performed, and thereby the adhesion reliability is compensated.

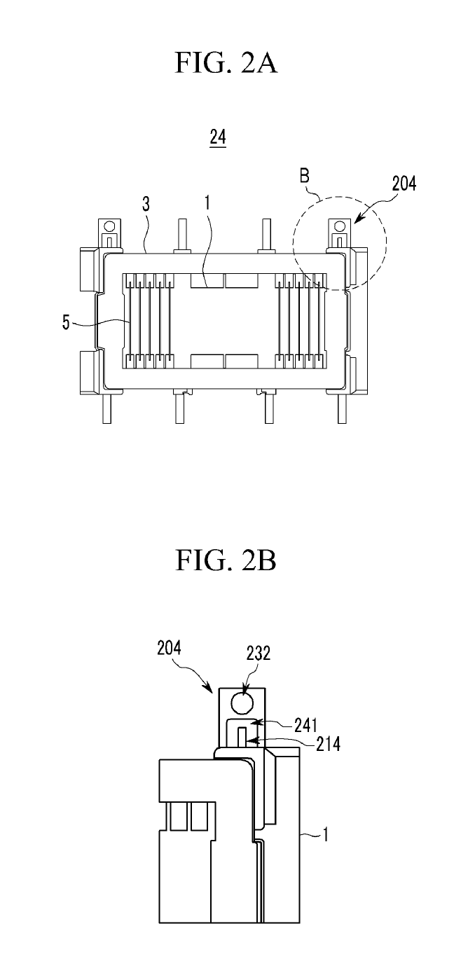

FIGS. 2A and 2B are top plan views showing a shape and a partial enlarged region of another exemplary embodiment of a transformer according to the present invention, respectively.

Referring to FIG. 2, a first hole 232 and a second hole 241 are formed inside the soldering pin 204 of a transformer 24.

A connection line pin 214 for the coil connection line of the transformer 24 is positioned inside the second hole 241.

In one exemplary embodiment, the connection line pin 214 may be wound with the coil at least once.

The connection line pin 214 is electrically connected to the soldering pin 204, and is inserted inside the bobbin 1 to be supported thereby.

As described above, in an exemplary embodiment wherein the connection line pin 214 is disposed in an inner region of the second hole 241, the soldering pin 204 functions to protect the connection line pin 214 such that the connection line pin 214 is stablely supported against an external impact.

Accordingly, the present exemplary embodiment provides a configuration which may prevent coil disconnection or other defects of the transformer 24 which may be generated when the connection line pin 214 of the transformer 24 is damaged by an external impact.

FIG. 3A is a perspective view of another exemplary embodiment of a transformer and a circuit board according to the present invention. FIG. 3B is a partially enlarged cross-sectional view of the another exemplary embodiment of the transformer and circuit board of FIG. 3A taken along line B-B′.

Referring to FIGS. 3A and 3B, when a transformer 25 is mounted to a circuit board 305, a soldering pin 205 of the transformer 25 is placed in the solder surface 315 formed in the circuit board 305 and is electrically connected thereto through a soldering process.

Here, to reduce the entire thickness of the circuit board 305 to which the transformer 25 is mounted, an empty space passes through the circuit board 305 and the transformer 25 is placed and mounted to the empty space, and thereby as shown in the enlarged cross-sectional view of FIG. 3B, the transformer 25 is protruded upward and downward with reference to the circuit board 305.

Accordingly, the thickness of the circuit board 305 mounted with the transformer may be reduced by the thickness of the circuit board 305 compared with the comparative configuration wherein the transformer is placed on the circuit board 305, and resultantly the entire thickness of electrical products including the circuit board 305 may be reduced.

Here, exemplary embodiments of the circuit board 305 may be a printed circuit board (“PCB”), a conductive layer may be provided thereon, and at least one wire may be formed.

Also, the soldering pin 205 and the connection line pin 214 may have the same structure as that of the exemplary embodiments of FIG. 1 or FIG. 2.

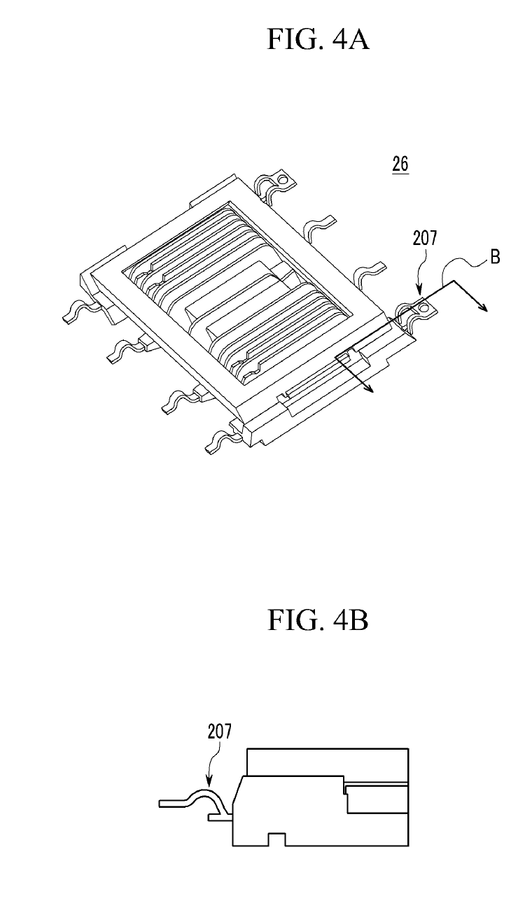

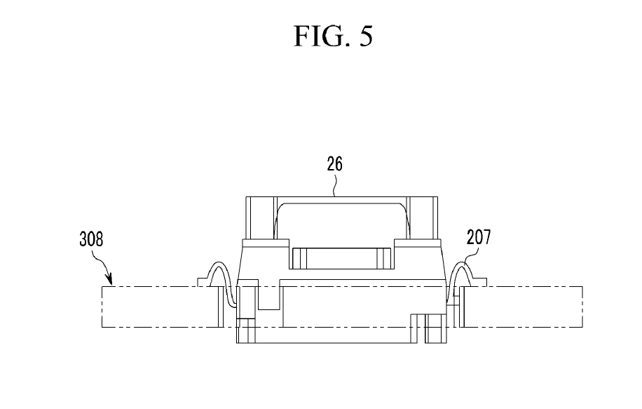

FIG. 4A is a front perspective view of another exemplary embodiment of a transformer 26 according to the present invention. FIG. 4B is a cross-sectional view of the exemplary embodiment of a transformer 26 taken along line B-B′. FIG. 5 is a cross-sectional view of the exemplary embodiment of a transformer 26 as it is mounted to a circuit board 308.

Referring to FIG. 4 and FIG. 5, the entirety of a soldering pin 207 of a transformer 26 does not have a planar shape, and at least a portion of the soldering pin 207 has a curved surface.

Exemplary embodiments include configurations wherein there may be more than one portion forming the curved surface, a plurality of curved surfaces may exist between the planar portions, and in another exemplary embodiment the entire soldering pin 207 may be formed of the curved surface.

Similar to the exemplary embodiment of FIG. 4 and FIG. 5, when the soldering pin 207 has the curved surface, the durability thereof is increased against defect generation such as external impact after the soldering process is performed when the transformer is mounted to a circuit board 308, and accordingly the adhesion reliability may be improved.

Here, similar to the exemplary embodiment of FIG. 3, the circuit board 308 has an empty space passing through the circuit board 308, and the transformer 26 is placed and mounted to the empty space such that the entire thickness of the circuit board 308 mounted with the transformer 26 may be reduced.

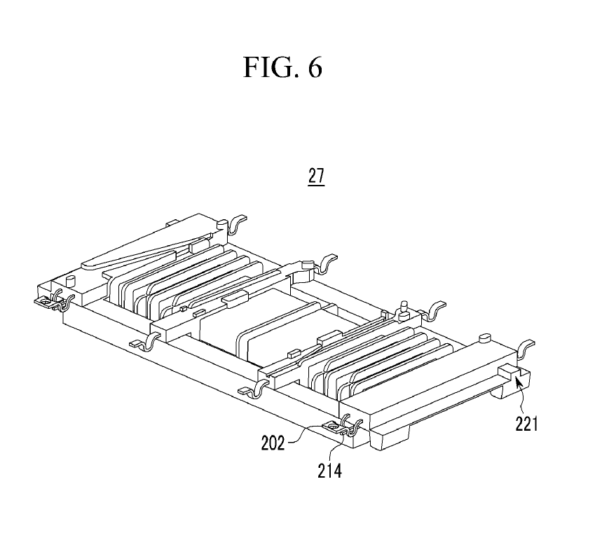

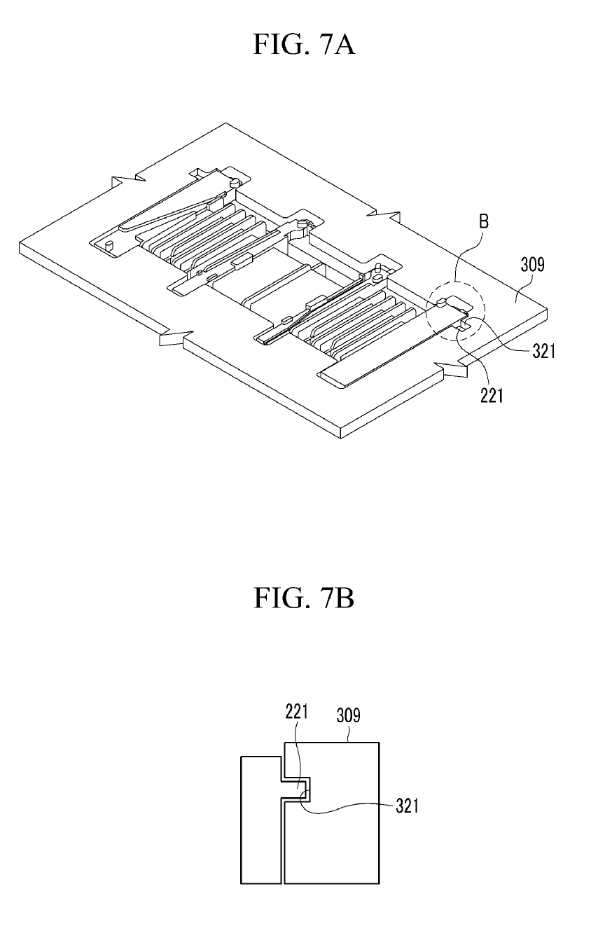

FIG. 6 is a rear perspective view of another exemplary embodiment of a transformer according to the present invention, and FIGS. 7A and 7B are a rear perspective view of a transformer of FIG. 6 in a state where it is mounted to a circuit board, and an enlarged view of the region B of FIG. 7A, respectively.

Referring to FIG. 6, a transformer 27 includes a mounting embossed part 221.

Exemplary embodiments include configurations wherein one or more mounting embossed parts 221 may be formed, and the shape thereof may be various solid shapes such as hexahedral, circular, and columnar, as well as a hexahedral shape as shown in FIG. 6.

Referring to FIGS. 7A and B, an empty space passing through a circuit board 309 is provided, and the transformer 27 is disposed and mounted to the empty space such that the entire thickness of the circuit board 308 including the transformer 27 may be reduced, and at least one mounting engraved part 321 is formed in the circuit board 309 to increase the adhesion intensity between the transformer 27 and the circuit board 309.

When mounting the transformer 27 to the circuit board 309, the mounting embossed part 221 formed in the transformer 27 is placed in the mounting engraved part 321 according to the position and the size of the mounting engraved part 321.

In such an exemplary embodiment, the mounting embossed part 221 of the transformer 27 is placed in the mounting engraved part 321 of the circuit board 309 such that a fixing force is generated which is substantially opposite to forces generated by external factors, such as shaking and vibration, thereby improving the reliability of the mounting of the transformer 27 in the circuit board 309.

Alternative exemplary embodiments include configurations wherein the mounting embossed part 221 may be formed in the circuit board 309, and the mounting engraved part may be formed in the transformer 27.

Alternative exemplary embodiments also include configurations wherein the mounting embossed part 321 or the mounting engraved part may be disposed in the bobbin 1.

Also, the soldering pin 202 and the connection line pin 214 of the transformer 27 may have the structure of the exemplary embodiments of FIGS. 1, 2, or 4.

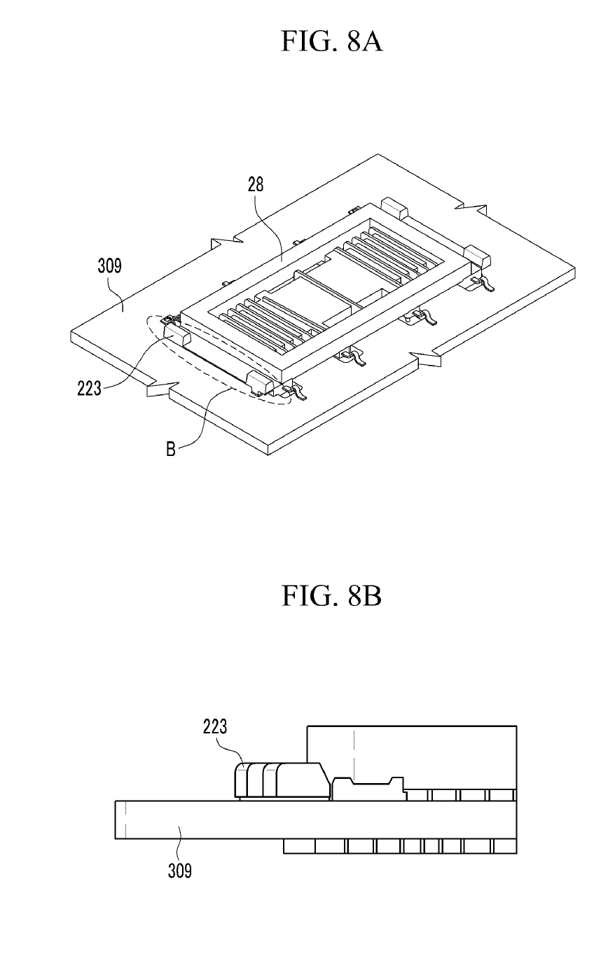

FIG. 8A is a front perspective view of another exemplary embodiment of a transformer 28 according to the present invention in a configuration wherein it is mounted to a circuit board 309.

Referring to FIG. 8, hang members 223 are formed at the both ends of the transformer 28.

The hang members 223 guide the transformer 28 to be hung and supported to the circuit board 309 when the transformer 28 is disposed to the empty space passing through the circuit board 309, thereby preventing the downward movement of the transformer 28 through the circuit board 309.

Alternative exemplary embodiments include configurations wherein the hang member 223 may be formed in the bobbin 1.

Here, the mounting embossed part 321 and the mounting engraved part 221 provided in the exemplary embodiment of FIG. 6 and FIG. 7 may also be applied, thereby further improving the fixing force.

Also, the soldering pin 202 and the connection line pin 214 of the transformer 28 may have the structure of any of the exemplary embodiments of FIGS. 1, 2, or 4.

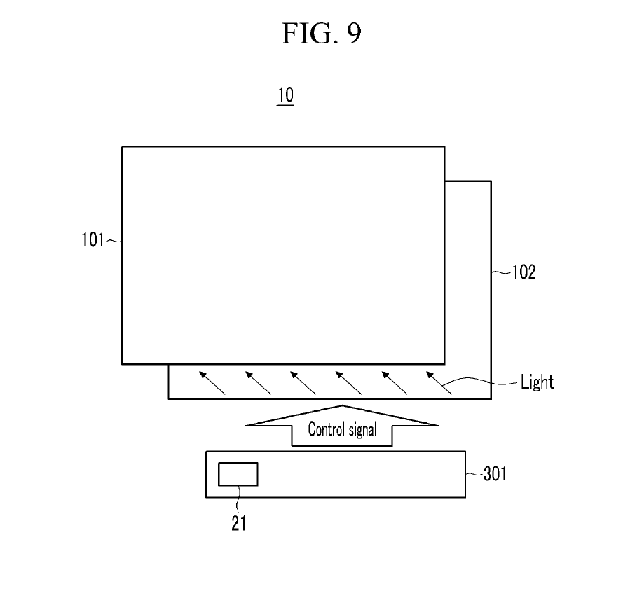

FIG. 9 is a schematic view of an exemplary embodiment of a display device according to the present invention.

FIG. 9 illustrates a transformer 21 and a circuit board 301 described in the above exemplary embodiments, and a display device 10 including the same.

The transformer 21 and the circuit board 301 described in the above exemplary embodiments may be a portion of the display device, and may consist of a portion of the electronic device or may provide a function for the operation of the electronic device.

The display device 10 of the exemplary embodiment of FIG. 9 may be a liquid crystal display.

The display device 10 of FIG. 9 may include a display panel 101, and may include a backlight unit 102 for providing light to the display panel 101.

The backlight unit 102 may include at least one light-emitting device, and the light-emitting device may be a cold cathode fluorescent lamp or another light-emitting device providing light, exemplary embodiments of which include a light emitting diode (“LED”).

The display device 10 may include at least one circuit board 301 and the transformer 21 mounted in the circuit board 301, and the circuit board 301 may control the backlight unit 102.

As described above, when increasing the adhesion reliability and reducing the thickness of the transformer and the circuit board in a mounted configuration, a reliability of the connection thereof and a reduction of the thickness thereof within the display device 10 and other electronic devices including the transformer and the circuit board may be obtained.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A transformer comprising:
a bobbin;
a coil wound to the bobbin;
a core inserted within the bobbin; and
a soldering pin disposed connected to the bobbin,
wherein the soldering pin has at least one first hole.

2. The transformer of claim 1, wherein a shape of the first hole is one of circular and elliptical.

3. The transformer of claim 1, further comprising a connection line pin which connects the coil to an outside,
wherein the soldering pin has a second hole and the connection line pin is disposed inside the second hole.

4. The transformer of claim 1, wherein the soldering pin includes at least one curved portion.

5. A circuit board assembly comprising:
a circuit board; and
a transformer mounted to the circuit board,
wherein the transformer includes a soldering pin which is soldered to the circuit board when the transformer is surface mount to the circuit board, and the soldering pin has at least one first hole.

6. The circuit board assembly of claim 5, wherein a shape of the first hole is one of circular and elliptical.

7. The circuit board assembly of claim 5, wherein the transformer further includes a connection line pin which connects a coil of the transformer to an outside, the soldering pin has a second hole, and the connection line pin is disposed inside the second hole.

8. The circuit board assembly of claim 5, wherein the soldering pin includes at least one curved portion.

9. The circuit board assembly of claim 5, wherein the circuit board has at least one mounting engraved part, and the transformer has at least one mounting embossed part which is placed within the mounting engraved part.

10. The circuit board assembly of claim 9, wherein the circuit board defines an empty space passing therethrough, the transformer further includes a hang member, the transformer is disposed in the empty space, and the hang member hooks circuit board and supports the transformer by the circuit board.

11. The circuit board assembly of claim 5, wherein the circuit board includes at least one wire.

12. The display device comprising:
at least one circuit board; and
a transformer including a soldering pin which is soldered to the circuit board, wherein the transformer is mounted to the circuit board,
wherein the soldering pin has at least one first hole.

13. The display device of claim 12, wherein the display device is a liquid crystal display including a display panel and a backlight unit which provides light to the display panel, and the circuit board controls the backlight unit.

14. The display device of claim 13, wherein the backlight unit includes at least one cold cathode fluorescent lamp.

15. The display device of claim 12, wherein a shape of the first hole is one of circular and elliptical.

16. The display device of claim 12, wherein the transformer further includes a connection line pin which connects the coil to an outside, the soldering pin has a second hole, and the connection line pin is disposed inside the second hole.

17. The display device of claim 12, wherein the soldering pin includes at least one curved portion.

18. The display device of claim 12, wherein the circuit board has at least one mounting engraved part, and the transformer has at least one mounting embossed part which is placed within the mounting engraved part.

19. The display device of claim 12, wherein the circuit board includes at least one wire.

20. The display device of claim 19, wherein the circuit board defines an empty space passing therethrough, the transformer further includes a hang member, the transformer is disposed in the empty space, and the hang member has a hooks the circuit board and supported the transformer by the circuit board.
